(19) United States
(12) Patent Application Publication
(10) Pub. No.: US 2024/0413364 A1
(43) Pub. Date: Dec. 12, 2024

(54) COMPRESSOR SYSTEM FOR A FUEL CELL SYSTEM

(71) Applicant: ZF Friedrichshafen AG, Friedrichshafen (DE)

(72) Inventor: Raphael Zwick, Wangen (DE)

(73) Assignee: ZF Friedrichshafen AG, Friedrichshafen (DE)

(21) Appl. No.: 18/701,019

(22) PCT Filed: Sep. 28, 2022
(86) PCT No.: PCT/EP2022/076925

§ 371 Date: Apr. 12, 2024

(30) Foreign Application Priority Data
Oct. 13, 2021 (DE) 10 2021 211 528.4

(51) Int. Cl. H01M 8/04746; H01M 8/04089; H01M 8/0438; H01M 8/04537

(52) U.S. Cl. CPC H01M 8/04753; H01M 8/04089; H01M 8/04425; H01M 8/04597; H01M 2250/20

(57) ABSTRACT

A compressor system is provided for a fuel cell system having at least one compressor stage with an electric motor. The compressor stage is set up to suck in and compress an air mass flow along a fluid path using the motor and to discharge the compressed air mass flow as a reactant feed. The compressor system also has a control unit configured to determine a current for supplying the electric motor and a rotational speed of the electric motor or a frequency of the current of the electric motor. In addition, the control unit is configured to ascertain a theoretical air mass flow value in the fluid path as a function of the current and the speed or as a function of the current and the frequency, and to control the motor as a function of the theoretical air mass flow value.

### RELATED APPLICATIONS

This application claims the benefit under 35 U.S.C. § 371 as a U.S. National Phase Application of application no. PCT/EP2022/076925, filed on 28 Sep. 2022, which claims the benefit of German Patent Application no. 10 2021 211 528.4 filed on 13 Oct. 2021, the contents of which are hereby incorporated herein by reference in their entireties.

### FIELD OF THE DISCLOSURE

The present invention relates to a compressor system for a fuel cell system, which is preferably used for a vehicle and can thus be referred to as a vehicle fuel cell system. The compressor system comprises at least one compressor stage for sucking an air mass flow, compressing it, and discharging the compressed air mass flow as a reactant feed. The compressor system also comprises a compressor control unit, which is set up to control the compressor stage. In addition, the compressor control unit is set up to be connected to a fuel cell control unit in a signaling manner and to receive control commands from the fuel cell control unit.

### BACKGROUND

Compressor systems for fuel cell systems are well known. Such compressor systems are used to supply a fuel cell of a fuel cell system with an oxygen-containing mixture of substances on the cathode side. This oxygen-containing mixture of substances is regularly supplied in the form of pressurized air sucked from the environment. Hydrogen is supplied to the fuel cell on the anode side. A reaction then takes place in the fuel cell, which requires monitoring and control of the reaction conditions and reactant quantities supplied in order to ensure that this takes place in a controlled manner. In particular, the quantities of oxygen and hydrogen supplied must be monitored and controlled in order to ensure efficient but also low-wear operation of the fuel cell. According to the state of the art, the task of monitoring and control is usually performed by the fuel cell control unit.

In known systems, communication takes place between the fuel cell control unit of the fuel cell system and the compressor arrangement for monitoring and control purposes. The fuel cell control unit receives measurement signals from a sensor in the fuel cell system that indicate the amount of oxygen, in particular the amount of air, being supplied to a fuel cell in the fuel cell system. If the measurement signals, namely the sensor readings, indicate that the amount of oxygen supplied, in particular air, is unsuitable for the desired reaction in the fuel cell, for example too low, it sends a control command to the compressor control unit to adjust the compressor output, for example by increasing the speed of an electric motor of the compressor stage. In this respect, a control loop is formed in which a reference variable is defined in the fuel cell control unit and in which the fuel cell control unit is used to ascertain a control difference between the reference variable and the measured variable received via the sensor. Depending on this difference, the compressor stage is then controlled by the compressor control unit in such a way that the controlled variable is adapted as precisely as possible to the reference variable and thus the desired amount of oxygen, in particular air, is provided for the fuel cell.

### SUMMARY

The fuel cell systems described generally enable satisfactory operation of a fuel cell, wherein such systems require a complex design of the individual components of the fuel cell system. In particular, complex data communication is required between the individual components. This complex structure, in particular the complex data communication, is prone to faults that can impair the continuous operation of the fuel cell system, so that it is desirable to simplify this structure. On the other hand, simplifying the design is advantageous in order to further reduce the costs of fuel cell systems and make them accessible to the mass market.

The task of the present invention is therefore to overcome the problems of the prior art. In particular, it is the task of the present invention to reduce the complexity of the structure of a fuel cell system.

The invention therefore proposes a compressor system according as disclosed herein.

Accordingly, the invention relates to a compressor system for a fuel cell system. Preferably, the fuel cell system is a vehicle fuel cell system that is set up to provide electrical energy for driving the vehicle. The compressor system comprises at least one compressor stage with an electric motor. Accordingly, a compressor system here comprises a single compressor stage but also a cascaded arrangement consisting of several compressor stages. The electric motor is preferably a synchronous motor. The electric motor is also preferably a permanently energized synchronous motor. The compressor stage is set up to suck an air mass flow with the motor. The compressor stage is also set up to compress the air mass flow sucked and to discharge the compressed air mass flow as a reactant feed. Preferably, the compressor stage is used to deliver the reactant feed to a fuel cell or a fuel cell stack, which is also called a fuel cell stack and consists of several fuel cells. The suction, compression, and discharge of the air mass flow takes place along a fluid path of the compressor system.

The compressor system also comprises a control unit. Preferably, the control unit comprises at least one control logic in the form of a microprocessor or computer and power electronics that are controlled by the control logic. The control unit is set up to determine a current to supply the electric motor. The current is preferably measured by the control unit. The control unit is also set up to determine a speed of the electric motor or a frequency of the current to supply the electric motor. In particular, the speed or frequency is also determined by measuring the speed or frequency of the current. Measuring the frequency of the current comprises, for example, monitoring the course of the current to supply the electric motor.

In addition, the control unit is set up to determine a theoretical air mass flow value in the fluid path of the air mass flow as a function of the specific current and the specific speed or the specific current and the specific frequency. This determination of the theoretical air mass flow value is carried out in particular by calculating the theoretical air mass flow value using an equation in which the current and the speed or the current and the frequency are taken into account. The control unit is also set up to control the motor of the compressor stage as a function of the theoretical air mass flow value. Control comprises, in particular, setting or regulating the motor speed and/or the motor torque.

The invention is based on the realization that an air mass flow value, which is usually measured with a sensor in the fluid path for controlling the motor in order to control the compressor stage, can also be determined theoretically. For example, the air mass flow value can be calculated by first determining a current torque (t) of the motor from the current and a supply voltage of the motor. Since the speed (s) is also determined and the motor should be known, so that motor characteristics (μ), comprising or corresponding to an efficiency of the motor, are known, a pressure (p) at the outlet of the compressor stage can be determined using the following formula:

$$p = {b}_{0} + s * {b}_{1} + t * {b}_{2} + {s}^{2} * {b}_{3} + {t}^{2} * {b}_{4} + μ * {b}_{5}$$

where bₓ are polynomial coefficients in this case.

If this pressure (p) is known, the air mass flow value (m) can be determined using the following formula:

$$\dot{m} = {a}_{0} + p * {a}_{1} + s * {a}_{2} + t * {a}_{3} + {p}^{2} * {a}_{4} + p * s * {a}_{5} + p * t * {a}_{6} + {s}^{2} * {a}_{7} + s * t * {a}_{8} + {t}^{2} * {a}_{9} + {p}^{3} * {a}_{10} + {p}^{2} * t * {a}_{11} + p * {s}^{2} * {a}_{12} + p * s * t * {a}_{13} + p * {t}^{2} * {a}_{14} + {s}^{3} * {a}_{15} + {s}^{2} * t * {a}_{16} + {t}^{3} * {a}_{17}$$

where aₓ are the polynomial coefficients in this formula.

This means that there is no need for a sensor for this measurement. By dispensing with a sensor for measuring the air mass flow, the costs for providing and calibrating the sensor are advantageously eliminated. There is also no need for cabling, which simplifies the overall design of a fuel cell system. The susceptibility of the fuel cell system to faults is also reduced, as the sensor itself or even the cabling cannot be exposed to defects. Furthermore, there is no need for an additional opening to insert the sensor into the fluid path or to lead the sensor cabling out of the fluid path. Such openings must be sealed to ensure the function of the fuel cell system, wherein such seals can age and thus be damaged. By dispensing with a sensor, the susceptibility to faults is further reduced.

Overall, this makes a fuel cell system cheaper and more reliable.

According to a first embodiment, the control comprises a compressor control unit for controlling the compressor stage. The compressor control unit is set up to receive an air mass flow target value from a fuel cell control unit. Accordingly, an interface is preferably provided to receive the air mass flow target value. Furthermore, the compressor control unit is set up to determine a control deviation between the air mass flow target value and the theoretical air mass flow value. The compressor control unit is also set up to control the electric motor as a function of the control deviation.

Accordingly, the compressor control unit, which essentially performs the task of controlling the electric motor, regulates the control of the motor itself. A fuel cell control unit used in conjunction with the described compressor control unit therefore no longer needs to regulate the air mass flow of the compressor stage compared to the state of the art. Instead, regulation takes place directly in the compressor control unit. Only the air mass flow target value must be provided by the fuel cell control unit, which controls the fuel cell system as a whole. Complex communication between a fuel cell control unit and a compressor control unit is therefore avoided.

According to an alternative embodiment, the control unit comprises the compressor control unit and a fuel cell control unit. The compressor control unit is set up to determine the theoretical air mass flow value and discharge it to the fuel cell control unit. The fuel cell control unit is set up to determine a target value, in particular a speed target value. The target value, which is in particular a speed target value, is determined at least as a function of the theoretical air mass flow value and preferably as a function of an air mass flow target value, which is also determined by the fuel cell control unit itself. The target value, in particular the speed target value, is then transmitted to the compressor control unit. The compressor control unit is also set up to receive the target value and to regulate the speed of the electric motor depending on the received target value or to control the motor as a function of the target value.

This enables the simple integration of the proposed compressor system into an existing fuel cell system. Accordingly, the fuel cell control unit essentially does not need to be adapted in the usual control loop of a fuel cell system to implement the present compressor system. Conventional fuel cell control units receive an air mass flow value from the sensor. To adapt to the compressor system proposed here, only the air mass flow value received from the sensor needs to be replaced by the theoretical air mass flow value from the compressor control unit. From this, standard fuel cell control units calculate a speed target value for the compressor system and transmit this to the compressor control unit.

Accordingly, the complex communication between compressor control unit and fuel cell control unit already described above is still accepted here, wherein the present compressor system can be integrated into an existing fuel cell system without complex modifications but at the same time the sensor can be dispensed with.

According to a further embodiment, the control unit is set up to additionally determine a voltage for supplying the electric motor and to additionally determine the theoretical air mass flow value as a function of the voltage. In principle, the voltage for supplying the motor of the compressor stage can be assumed to be essentially constant. A motor torque for determining the air mass flow value can therefore also be ascertained using a voltage value that is assumed to be constant and a specific current value. Nevertheless, taking into account the current specific, in particular measured, supply voltage of the electric motor is advantageous, as voltage fluctuations are also taken into account. These occur, for example, due to an energy storage unit that provides or contributes to the voltage for operating the compressor system, for example during a particular driving situation of a vehicle. The theoretical air mass flow value can thus be determined even more precisely.

According to a further embodiment, the compressor system comprises a sensor arrangement comprising one or more sensors. The sensor arrangement preferably comprises a pressure sensor, a GPS sensor, a humidity sensor, and/or a temperature sensor. The sensor arrangement is located outside the fluid path. The sensor arrangement is set up to determine measured values of the environment outside the fluid path, in particular to measure them, and to determine the theoretical air mass flow as a function of the measured value or measured values. Measured values are preferably air pressure, humidity, and/or altitude in the vicinity of the compressor system. The height is preferably used to determine the ambient pressure or oxygen content of the air in the vicinity of the compressor system as a measured value.

The sensor arrangement of the compressor system makes it possible to determine the theoretical air mass flow value, which is also dependent on the properties of the air being sucked, even more precisely.

According to a further embodiment, the control unit comprises at least one interface for connecting to a bus, in particular a CAN bus, preferably of a vehicle. The interface is set up to determine measured values of the environment outside the fluid path, in particular air pressure and/or humidity via sensors connected to the bus, and to determine the theoretical air mass flow value as a function of the measured value. According to this embodiment, an existing sensor system of a vehicle is used, which is already used for the air conditioning of the passenger compartment, for example. This means that no additional sensors need to be provided to more accurately determine the theoretical air mass flow rate through the compressor system.

According to a further embodiment, the compressor system further comprises a valve which is set up to vary a pressure in at least one fuel cell of the fuel cell system. The valve can preferably be arranged at an input of at least one fuel cell of the fuel cell system. Furthermore, the control unit is set up to determine a theoretical pressure value as a function of the current and the speed or the current and the frequency, and preferably also the measured values. The theoretical pressure value is also preferably determined by calculation. Furthermore, the control unit is set up to control the valve as a function of the theoretical pressure value.

Providing a valve in a fuel cell system and controlling or regulating it as a function of a pressure value is generally known. However, the state of the art provides for a pressure sensor to be arranged in the fuel cell system in order to measure the pressure value. According to this embodiment, the pressure sensor can now also be dispensed with, as the pressure value is calculated as a theoretical pressure value. Accordingly, there is no need for cabling and an opening for the sensor on the fuel cell system. Communication between the control unit and the sensors is also no longer necessary, which further reduces the effort required for communication. Furthermore, the overall system's susceptibility to faults is reduced as the pressure sensor is no longer required.

According to a further embodiment, the compressor control unit of the control unit is set up to receive a pressure target value from a fuel cell control unit and to determine a control deviation between the pressure target value and the theoretical pressure value. The compressor control unit is also set up to control the valve as a function of the control deviation.

A fuel cell control unit can thus be completely freed from the regulation tasks required to operate a fuel cell in order to supply an air mass flow. Instead, these regulation tasks are completely shifted to the compressor control unit. Communication between a compressor control unit and a fuel cell control unit can thus be reduced to a minimum, namely to the receipt of the target value or target values for the air mass flow and the pressure from the fuel cell control unit by the compressor control unit.

According to a further embodiment, the compressor control unit is set up to determine the theoretical pressure value and transmit it to the fuel cell control unit. Furthermore, the fuel cell control unit is set up to control the valve as a function of the theoretical pressure value.

This means that the usual structure of a fuel cell system can be retained, and the compressor control unit can be easily integrated into such a fuel cell system.

The invention further relates to a fuel cell system comprising a compressor system according to one of the preceding embodiments and a fuel cell or a fuel cell stack comprising a plurality of fuel cells.

In addition, the invention relates to a vehicle with the compressor system according to one of the aforementioned embodiments or with a fuel cell system according to the aforementioned embodiment.

The invention also relates to a method for operating a fuel cell system with a compressor system according to one of the aforementioned embodiments. According to the method, an electric motor of a compressor stage is used to suck an air mass flow along a fluid path, compress it and discharge the compressed air mass flow as a reactant feed. A current for supplying the electric motor and a speed of the electric motor or a frequency of the current for supplying the electric motor are determined with a control unit of the compressor system. In addition, a theoretical air mass flow value in the fluid path is determined as a function of the current and the speed or as a function of the current and the frequency. In addition, the motor is controlled as a function of the theoretical air mass flow value.

According to one embodiment of the method, the control unit is a compressor control unit. The compressor control unit receives an air mass flow target value from the fuel cell control unit and determines a control deviation between the air mass flow value and the theoretical air mass flow target value. Furthermore, the electric motor is controlled as a function of the control deviation.

According to a further embodiment, the control unit comprises the compressor control unit and a fuel cell control unit. The theoretical air mass flow value is determined with the compressor control unit and the theoretical air mass flow value is transferred to the fuel cell control unit. Depending on the theoretical air mass flow value, the fuel cell control unit determines a target value, which is in particular a speed target value, and transmits this to the compressor control unit. The compressor control unit also regulates the electric motor as a function of the target value.

The invention also relates to a computer program product comprising instructions which, when executed on a computer, cause the computer to perform the steps of the aforementioned method.

The advantages and preferred embodiments of the compressor system described above and of the fuel cell system described above are also advantages and preferred embodiments of the method according to the invention and vice versa, so that reference is made to the above explanations in order to avoid repetition.

### BRIEF DESCRIPTION OF THE DRAWINGS

Further embodiments are also possible with reference to the exemplary embodiments described in more detail below. The figures here show the following:

FIG. 1: a fuel cell system according to an exemplary embodiment,

FIG. 2: a fuel cell system according to a further exemplary embodiment,

FIG. 3: a method according to an exemplary embodiment, and

FIG. 4: a method according to a further exemplary embodiment.

### DETAILED DESCRIPTION

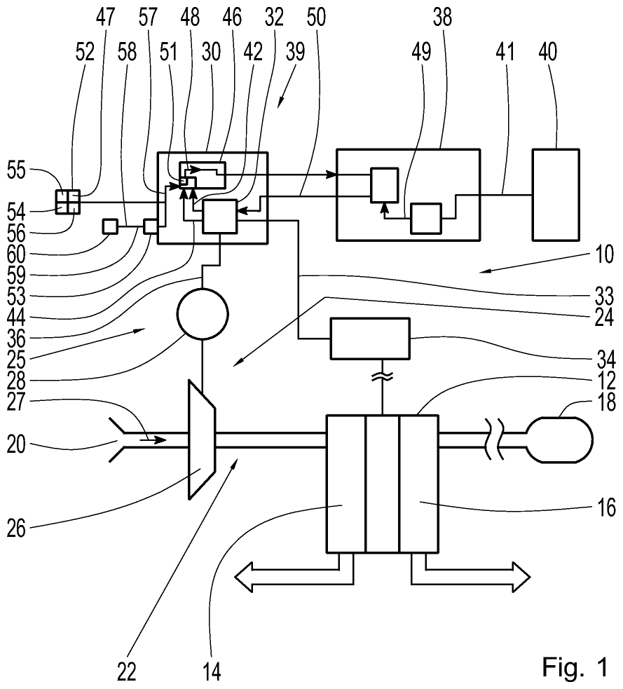

FIG. 1 shows a fuel cell system 10 with a fuel cell 12. The fuel cell 12 has a cathode 14 and an anode 16. A gas, for example hydrogen, is fed to the anode 16 from a pressurized container 18 and air is fed to the cathode 14. The air is supplied via an air inlet 20 along a fluid path 22. For this purpose, a compressor stage 24 of a compressor system 25 is provided, which sucks the air as an air mass flow 27 via the air inlet 20, compresses it, and discharges the compressed air mass flow 27 to the fuel cell 12.

For this purpose, the compressor stage 24 comprises a compressor 26 and a motor 28 that drives the compressor 26. The motor 28 is controlled via a compressor control unit 30. For this purpose, the compressor control unit 30 comprises an inverter 32, which converts a DC voltage 33 from an energy source 34 into an AC voltage 36 for the motor 28. A fuel cell control unit 38 is also provided, which communicates with a vehicle control unit 40 and coordinates the components of the fuel cell system 10 and, in particular, exchanges data with the compressor control unit 30.

According to this exemplary embodiment, the speed 42 of the motor 28 and the current 44 drawn by the motor 28 are determined by a computer unit 46 in the inverter 32 of the compressor control unit 30 when the motor 28 is currently being controlled by the inverter 32. A theoretical air mass flow value 48 is determined from this in the computer unit 46 and this value 48 is transmitted to the fuel cell control unit 38. The fuel cell control unit 38 together with the compressor control unit 30 can also be generally referred to as control unit 39. The fuel cell control unit 38 now ascertains a target speed 50 as a function of the theoretical air mass flow value 48 and an air mass flow target value 49, which is ascertained by a driving situation 41 specified by the vehicle control unit 40, and transmits this to the compressor control unit 30. The compressor control unit 30 then uses this target speed 50 to adapt the control of the motor 28 by the inverter 32 in order to regulate it to the target speed 50. To calculate the air mass flow value 48, an actual torque of the motor 28 is preferably first calculated from the value of the DC voltage 33 and the determined current 44. Together with the determined speed and the motor characteristics 51 stored in the computer unit 46, the air mass flow value 48 can be calculated.

Furthermore, a sensor arrangement 52 is connected to the compressor control unit 30, which comprises a pressure sensor 54, a humidity sensor 56, a temperature sensor 55 and a GPS sensor 47. Measured values 57 are received from the sensor arrangement 52 by the computer unit 46 and taken into account when determining the theoretical air mass flow value 48. Furthermore, the compressor control unit 30 is connected via an interface 53 to a bus 58 of a vehicle, which is in particular a CAN bus 59. A further sensor arrangement 60 is connected to the bus 58 so that the measured values 57 can be received by the further sensor arrangement 60 in the event of a failure of the sensor arrangement 52. Alternatively, according to an exemplary embodiment not shown here, the fuel cell system 10 comprises only the sensor arrangement 52 or the interface 53 for receiving the measured values 57.

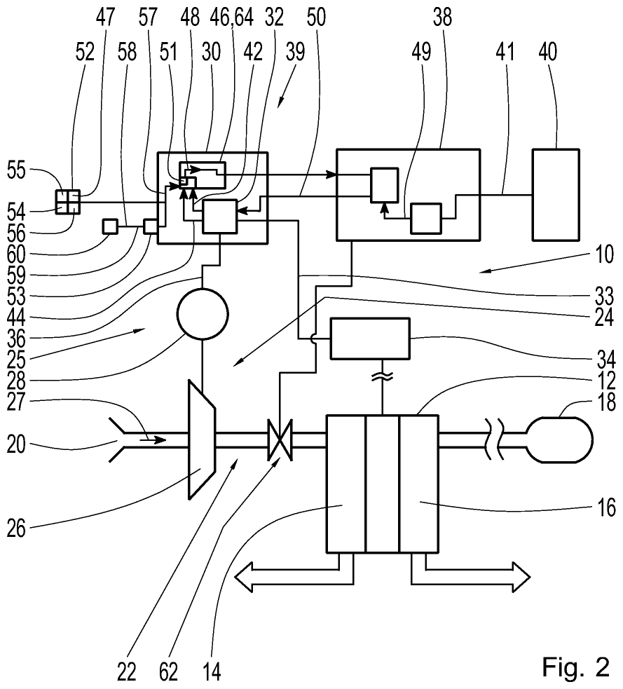

FIG. 2 shows a further exemplary embodiment, wherein the same reference numbers indicate the same features. FIG. 2 differs from the exemplary embodiment of FIG. 1 in that a valve 62 is provided with which a pressure in the fuel cell 12 can be regulated. According to this exemplary embodiment, the calculation unit 46 is also set up to determine a theoretical pressure value 64 in the fluid path 22 as a function of the speed 42 and the current 44 and to transmit this to the fuel cell control unit 38. The fuel cell control unit 38 is then set up to control the valve 62 as a function of this theoretical pressure value 64.

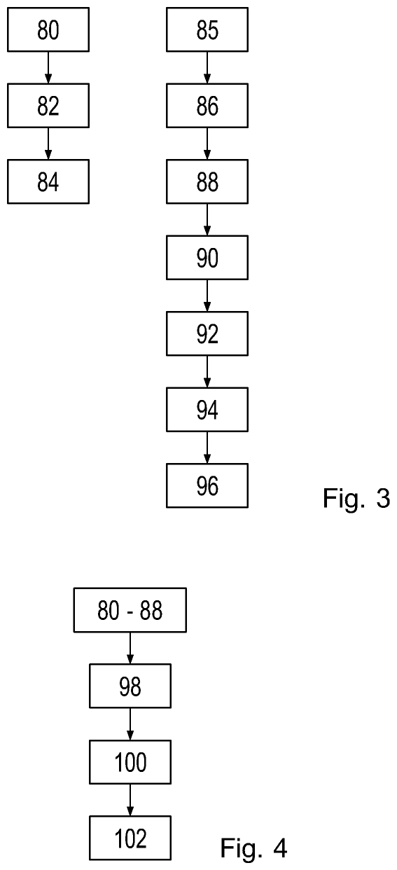

FIG. 3 shows the steps of the method according to an exemplary embodiment. In step 80, an air mass flow 27 is sucked in. In step 82, the air mass flow 27 is compressed and in step 84, the compressed air mass flow 27 is discharged as a reactant feed. In parallel, in step 85, a rotational speed 42 of a motor 28 used to perform steps 80 to 84 is determined. In step 86, the current 44 of the motor 28 is determined. In step 88, a theoretical air mass flow value 48 is ascertained as a function of the current 44 and the speed 42. In step 90, this air mass flow value 48 is sent to a fuel cell control unit 38. In step 92, the fuel cell control unit 38 determines a target speed 50 for the electric motor 28 as a function of the theoretical air mass flow value 48 and in step 94 transmits the target speed 50 to the compressor control unit 30. In step 96, the motor 28 is then controlled as a function of the theoretical air mass flow value 48, namely as a function of the target speed 50 ascertained from this.

FIG. 4 again shows steps 80 through 88, which are carried out identically. After step 88, however, an air mass flow target value 49 is received by the compressor control unit 30 in a step 98, and a control deviation is determined in step 100 as a function of the received target value and of the theoretical air mass flow 27. In step 102, the electric motor 28 is then controlled as a function of the control deviation.

### LIST OF REFERENCE NUMERALS

10 Fuel cell system
12 Fuel cell
14 Cathode
16 Anode
18 Pressurized container
20 Air inlet
22 Fluid path
24 Compressor stage
25 Compressor system
26 Compressor
27 Air mass flow
28 Motor
30 Compressor control unit
32 Inverter
33 DC voltage
34 Energy source
36 AC voltage
38 Fuel cell control unit
39 Control unit
40 Vehicle control unit
41 Driving situation
42 Speed
44 Current
46 Computing unit
47 GPS sensor
48 Air mass flow value
49 Air mass flow target value
50 Target speed
51 Motor characteristics
52 Sensor arrangement
53 Interface
54 Pressure sensor
55 Temperature sensor
56 Humidity sensor
57 Measured values
58 Bus
59 CAN bus
60 Further sensor arrangement
62 Valve
64 Theoretical pressure value
80 Sucking in
82 Compression
84 Dispensing
85 Determining the speed
86 Determining a current
88 Ascertaining a theoretical mass flow value
90 Transmission of the theoretical mass flow value
92 Determining a target speed
94 Sending the target speed to compressor control unit
96 Controlling motor
98 Receipt of air mass flow target value
100 Determining control deviation
102 Control as a function of control deviation

1. A compressor system (25) for a fuel cell system (10), the compressor system comprising:
at least one compressor stage (24) which has an electric motor (28) and is configured to suck in (80) and compress (82) an air mass flow (27) along a fluid path (22) using the electric motor (28), and to discharge (84) the compressed air mass flow (27) as a reactant feed;
wherein the control unit (39) is configured to:
determine an electric current (44) for supplying the electric motor (28);
determine a rotational speed (42) of the electric motor (28) or a frequency of the current (44) of the electric motor (28);
ascertain a theoretical air mass flow value (48) in the fluid path (22) as a function of the current (44) and the rotational speed (42) or as a function of the current (44) and the frequency; and
control the electric motor (28) as a function of a theoretical air mass flow value (48).

2. The compressor system according to claim 1, wherein the control unit (39) comprises a compressor control unit (30) configured to:
receive an air mass flow target value (49) from a fuel cell control unit (38);
determine a control deviation between the air mass flow target value (49) and the theoretical air mass flow value (48); and
control the electric motor (28) as a function of the control deviation.

3. The compressor system (25) according to claim 1,
wherein the control unit (39) comprises a compressor control unit (30) and a fuel cell control unit (38);
wherein the compressor control unit (30) is configured to determine the theoretical air mass flow value (48) and to transmit it to the fuel cell control unit (38);
wherein the fuel cell control unit (38) is configured to determine a speed target value (50) as a function of the theoretical air mass flow value (48) and transmit the speed target value (50) to the compressor control unit (30); and
wherein the compressor control unit (30) is further configured to receive the target value (50) and to regulate the speed (42) of the electric motor (28) as a function of the received target value (50).

4. The compressor system (25) according to claim 1, wherein the control unit (39) is further configured to determine a voltage (33) for supplying the motor (28) and to determine the theoretical air mass flow value (48) as a function of the voltage (33).

5. The compressor system (25) according to claim 1, further comprising one or more sensor selected from a pressure sensor (54), a GPS sensor (47), a humidity sensor (56), and a temperature sensor (55), the one or more sensor arranged outside the fluid path (22) of the compressor stage (24), the one or more sensor configured to determine one or more measured values (57) of an environment outside the fluid path (22), the one or more measured values (57) selected from an air pressure, a humidity, and an altitude, and further configured to determine the theoretical air mass flow value (48) as a function of the one or more measured values (57).

6. The compressor system (25) according to claim 5, comprising:
at least one interface (53) configured for connection to a bus (58) bus (59), the at least one interface in order to determine the one or more measured values (57) of the environment outside the fluid path (22) via the interface (53) and to determine the theoretical air mass flow value (48) as a function of the one or more measured values (57).

7. The compressor system (25) according to claim 1, further comprising:
a valve (62) configured to vary a pressure in at least one fuel cell (12) of the fuel cell system (10); and
wherein the control unit (39) is further configured to ascertain a theoretical pressure value (64) as a function of the current (44) and the rotational speed (42) or as a function of the current (44) and the frequency, and to control the valve (62) as a function of the theoretical pressure value (64).

8. The compressor system (25) according to claim 7, wherein the control unit (39) comprises a compressor control unit (30) and a fuel cell control unit (38), the compressor control unit (30) configured to receive a pressure target value from the fuel cell control unit (38), to determine a control deviation between the pressure target value and the theoretical pressure value (64), and to control the valve (62) as a function of the control deviation.

9. The compressor system (25) according to claim 7, wherein the control unit (39) comprises a compressor control unit (30) and a fuel cell control unit (38), wherein the compressor control unit (30) is configured to determine the theoretical pressure value (64) and transmit it to the fuel cell control unit (38), and the fuel cell control unit (38) is configured to control the valve (62) as a function of the theoretical pressure value (64).

10. A fuel cell system (10) comprising:
a compressor system (25) according to claim 1; and
a fuel cell (12) or a fuel cell stack comprising a plurality of fuel cells (12).

11. A vehicle comprising the fuel cell system (10) according to claim 10.

12. A method of operating a fuel cell system (10) having a compressor system (25) according to claim 1, the method comprising the steps carried out with the compressor stage (24):
sucking in an air mass flow (27) to provide a sucked-in air mass flow (27);
compressing a sucked-in air mass flow (27) to provide a compressed mass air flow (27); and
discharging (84) the compressed air mass flow (27) as reactant feed;
wherein the control unit (39) of the compressor system (25) performs the further following steps:
determining (86) a current (44) for supplying the electric motor (28);
determining (85) a rotational speed (42) of the electric motor (28) or a frequency of the current (44) for supplying the electric motor (28);
ascertaining (88) a theoretical air mass flow value (48) as a function of the current (44) and the speed (42) or the current (44) and the frequency; and
controlling (96) the motor (28) as a function of the theoretical air mass flow value (48).

13. The method according to claim 12, further comprising the steps of:
receiving (98) an air mass flow target value (49) from a fuel cell control unit (38) by the compressor control unit (30);
determining (100) a control deviation between the air mass flow target value (49) and the theoretical air mass flow value (48); and
controlling (102) the electric motor (28) as a function of the control deviation.

14. The method according to claim 12, further comprising the steps of:
determining (88) the theoretical air mass flow value (48) with the compressor control unit (30);
transmitting (90) the theoretical air mass flow value (48) to the fuel cell control unit (38);
determining (92) a target value (50) as a function of the theoretical air mass flow value (48) by the fuel cell control unit (38);
transmitting (94) the target value (50) to the compressor control unit (30) by the fuel cell control unit (38);
receiving the target value (50) by the compressor control unit (30); and
regulating the speed (42) of the electric motor (28) as a function of the received target value (50) by the compressor control unit (30).

15. A computer program product comprising instructions which, when executed on a computer, perform the steps of the method according to claim 12.
